(19) United States
(12) Patent Application Publication
(10) Pub. No.: US 2025/0104294 A1
(43) Pub. Date: Mar. 27, 2025

(54) COMPUTER-BASED SYSTEMS TO IMPLEMENT DIGITAL MEDIA AND MIXED REALITY AND METHODS OF USE THEREOF

(71) Applicant: Frederick T. CORDER, Bowie, MD (US)

(72) Inventor: Frederick T. CORDER, Bowie, MD (US)

(21) Appl. No.: 18/896,832

(22) Filed: Sep. 25, 2024

Related U.S. Application Data
(60) Provisional application No. 63/584,990, filed on Sep. 25, 2023.
(60) Provisional application No. 63/669,330, filed on Jul. 10, 2024.

(51) Int. Cl. G06T 11/00; G06F 21/31; G06K 7/14

(52) U.S. Cl. CPC G06T 11/00; G06F 21/31; G06K 7/1417

(57) ABSTRACT

In some embodiments, the present disclosure provides an exemplary system and method that may include steps of scanning, by a processor, a particular quick response digital code using a device associated with a user of a plurality of users; accessing, by the processor and in response to scanning the digital code, an interface associated with the device based on a first prompt to the user; performing, by the processor, an authentication step to verify identity of the user and the device; triggering, by the processor and in response to the performing of the authentication step, an action of an mixed reality tool based on the device hovering over a chosen image; and generating, by the processor, mixed reality content utilizing a particular application based on the particular digital code.

### CROSS REFERENCE TO RELATED APPLICATION

This application claims the benefit of U.S. Provisional Application No. 63/584,990 filed Sep. 25, 2023, and U.S. Provisional 63/669,330 filed Jul. 10, 2024, the contents of which are incorporated herein by reference in their entirety.

### FIELD OF THE INVENTION

This present disclosure generally relates to computer-based systems to implement digital media and mixed reality and methods of use thereof.

### BACKGROUND

Augmented reality is an interactive experience that enhances the real world with computer-generated perceptual information. Using software, apps, and hardware such as AR glasses, augmented reality overlays digital content onto real-life environments and objects.

### SUMMARY

The present disclosure discloses computer-implemented systems and methods, including software application tools and related methods of scanning, by a processor, a particular quick response digital code using a device associated with a user or a plurality or users; accessing, by the processor and in response to scanning the digital code, a imaging application associated with the device based on a prompt to the user; performing, by the processor, an authentication step to verify identity of the user, where the authentication step includes a prompt for a system generated password; triggering, by the processor and in response to the performing of the authentication step, an action of a mixed reality tool based on the device communicating with a chosen image; and generating, by the processor, augmented reality content utilizing a web application based on the particular digital code.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 is a block diagram of an environment for mixed reality content via a mixed reality tool, in accordance with one or more embodiments of the present disclosure.

FIG. 2 is an illustration of an application of mixed reality content on a plurality of modules, in accordance with one or more embodiments of the present disclosure.

FIG. 3 is a flow diagram of an example process for viewing mixed reality reusable programmable greeting cards, in accordance with one or more embodiments of the present disclosure.

FIG. 4 is a flow diagram of an example process for viewing mixed reality virtual world, in accordance with one or more embodiments of the present disclosure.

FIG. 5 is a flow diagram of an example process for viewing mixed reality live programmable animated representation of a establishments containing an ordering portal on print media such as a refrigerator magnet or flyer, in accordance with one or more embodiments of the present disclosure.

FIG. 6 is a flow diagram of an example process for viewing mixed reality poster and print media for musical artists, in accordance with one or more embodiments of the present disclosure.

FIG. 7 is a flow diagram of an example process for viewing mixed reality of continuously updated animated virtual world through stickers and other print media, in accordance with one or more embodiments of the present disclosure.

FIG. 8 is a flow diagram of an example process for mixed reality sticker encoded with content, in accordance with one or more embodiments of the present disclosure.

FIG. 9 is a flow diagram of an example process that displays live video, in accordance with one or more embodiments of the present disclosure.

FIG. 10 is a flow diagram of the mixed reality tool from a user perspective, in accordance with one or more embodiments of the present disclosure.

FIG. 11 is a flow diagram of the mixed reality tool from a backend system perspective, in accordance with one or more embodiments of the present disclosure.

FIG. 12 illustrates the sample HTML code that activates the mixed reality tool, in accordance with one or more embodiments of the present disclosure.

FIG. 13 is a flow diagram of an exemplary process for viewing mixed reality data, in accordance with one or more embodiments of the present disclosure.

FIG. 14 is a flow diagram of an exemplary process for interacting with mixed reality data, in accordance with one or more embodiments of the present disclosure.

FIG. 15 is a flow diagram of an exemplary process of communication between a web interface and a computing device interacting with mixed reality data, in accordance with one or more embodiments of the present disclosure.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a creator interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, daily, several days, weekly, monthly, etc.

As used herein, the term “runtime” corresponds to any behavior that is dynamically determined during an execution of a software application or at least a portion of software application.

At least some embodiments of the present disclosure provide technological solution(s) to at least one technological computer-centered problem associated with generating augmented reality environments based on existing digital media content. The present disclosure relates generally to the creation of augmented reality based of the supplied and existing digital media content for entertainment purposes but can also be useful for industrial and organization applications. In some embodiments, the present disclosure details that one practical solution may utilize a mixed reality tool that allows clients the ability to actively interact and share information about their organizations' activities. Embodiments of the present disclosure provides at least one new way to share digital media content, communicate and exchange data through the use of tangible media e.g., fridge magnets, postcards, posters, stickers, pins, wearables, and use of mobile phones. In some embodiments, the present disclosure may employ a data frame packet process or other software application process to enable a user to access digital element e.g., collected video and audio. The present disclosure may allow the client-created content to be transmitted via AR modules, e.g., the embedded, programable, real-time representing looping video to travel with clients. In some embodiments, the present disclosure may allow the users who receives the QR code or other readable medium to access to the interactive video, image, audio, or broadcast by activating it through a particular augmented reality web application. According to the present disclosure, a plurality of informative features can also be embedded and displayed with by way of example images, text, photos and art.

An exemplary mixed reality tool may include an augmented reality experience that is infinitely programmable alongside a virtual reality experience that interconnects augmented reality content and virtual reality content, real-time simulcast broadcasting, with built-in non-fungibility and multi-factor authenticity encoded into licensed comics, stickers, pins, wearables, and posters, without the headaches of downloading an app or scanning a QR code. In some embodiments, this provides a plurality of products into exclusive streaming platforms looping hundreds of hours of programmable content. According to the present disclosure an entire Ironman comic book can be contained in or otherwise accessed from a postcard sized form factor with an embedded NFC chip for seamless tap-to-view functionality. Broadcasting a live looping dramatically read motion comic is broadcastable in real time by a famous actor and cast, with scheduled programming such as live interviews with actors, artists, directors, documentaries, highlighting comic creations peppered with a “Catch Me If You Can” hyperlink, exclusive discounts on comics, toys and theme parks. Each mixed reality device, e.g., postcard is created with a unique URL or readable medium which can be assigned, e.g., an owner's name and sub owners' name seamlessly at the time of purchase thus allowing the digital media and/or mixed reality, e.g., comic to act as a multi-factor authenticated pass for the holder. For example, an AR Deadpool comic has ceased its programming to display a golden AMC ticket granting the owner One Day Pre-access to a Deadpool and Wolverine movie. The owner presents his Marvel comic at participating AMC ticket booths, where via an authenticator server may identify the comic as authentic and unused and prompts the ticket counter to request matching identification. This not only turns a previously once readable likely to be resold comic into a often revisited product but it also gives Marvel a direct bond with its reader and collectors in a way the industry has never seen.

In some embodiments, the embedded, assembled and/or associated digital media content accessible through QR activation and use of the particular web application is referred to as a mixed reality engine. The mixed reality engine may provide access to mixed reality content that includes digital, virtual, and multimedia content onto real-life environments. In certain embodiments, the mixed reality content may include online media, digital media, multimedia, social media, physical surfaces, live broadcast, rebroadcast, recorded broadcast, video, live augmented reality, continuous broadcast streams, etc. The reference to digital media may refer to photos, recorded voice, live-streaming content and pre-recorded videos. The term image means any content that may be displayed. The system and method may utilize the particular web application to assemble multimedia data that includes photos, recorded voice, video and text created and submitted by one or more users using the computer implemented methods and systems software applications and services. In some embodiments, there is no requirement to use hypertext or hypermedia processes to assemble or present the multimedia elements to users. In certain embodiments, a particular user may refer to an administrator, and the administrator may provide access to the mixed reality content via the mixed reality tool to the plurality of user. In certain embodiments, the administrator may automatically modify the mixed reality content in real-time to modify a broadcast, update a comic book, and/or schedule a live meet and greet via the mixed reality tool.

Embodiments of the present disclosure may provide an operation of accessing digital media creation that expands the use of photos, voice, audio and video into a dynamic multimedia environment. In some embodiments, the mixed reality tool expands the pairing of print and digital media for entertainment, industrial, and organization use. The methods may include embedding recorded digital video into print media such as posters, stickers, pins, and wearables, etc., that can be accessed to by activating the activation medium or code, e.g., the QR code, and using the particular web application. The digital content created are compatible with all known computer and mobile devices with activation medium or code scanning capability, such as smart phones and/or smart tablets with cameras. The digital media content created according to embodiments of the disclosure become alive on a graphical user interface via a continuous and interactive feed that turns the printout material into digital viewing portals to growing digital worlds or real-life places in real-time. In some embodiments, the pin may refer to a wearable system that can be used in combination with a sticker book that includes a plurality of trigger images, each trigger image providing different mixed reality content. For example, a smart hoodie with a waterproof NFC sown inside may serve as a trigger image via a label pin that generates mixed reality content for the mixed reality tool. In certain embodiments, the pin and/or smart wearable may utilize the mixed reality tool to serve as a gaming system, where each pin may provide additional mixed reality content.

The computer implemented systems and methods are particularly useful on upgrading artist's artwork, printout media of different industries by adding augmented reality. The mixed reality tool may comprise a generated activation medium or code, digital media supplied by clients, users' mobile device with reading or scanning capability and printout material. In some embodiments, the users can access the services provided by the particular web application.

The users may use a mobile device such as a smart phone to access the mixed reality web application via the mixed reality tool. In certain embodiments, the users can view administrator provided media by scanning the provided print media. In some embodiments, the users are typically the clients, potential customers, existing customers, fans, or followers. In certain embodiments, the user may utilize software or hardware such as mixed reality smart wear devices, phones, computers, tablets, camera, scopes and retina detection or any other interactive sensory devices to access the mixed reality tool.

According to exemplary embodiments, a user may identify one or more other members associated with the organization, business or entity, with which the client would like to share to their users. Using the particular web application, the user utilizes the mixed reality tool to send the digital media including the details from the client to the additional users. The users may then access the augmented reality features within the mixed reality tool, i.e. watch live concerts, to view pre-recorded looping videos and any other broadcasts set to selected global times and livestreams.

Additional aspects, objectives, features and advantages of the present disclosure will become apparent from the following description of the preferred embodiments with reference attached drawings.

In some embodiments, the mixed reality tool uses augmented reality (AR) technology and virtual reality (VR) simultaneously that generates a mixed reality content that enhances the real-world environment by overlaying digital information, media, animation 102 on to a trigger image 110 that the administrator can print in different materials such as postcard 106, sticker 107, poster 108 and magnet 109 and supply to users 105. In certain embodiments, the trigger image may be included on wearable smart devices, such as shirts, hats, and smart watches that can display a digital code to interact with the mixed reality tool. The exemplary mixed reality tool uses the trigger image 110 that the users 105 utilize to activate invention. In some embodiments, the exemplary mixed reality tool may add value to printout materials by blending the virtual and physical worlds together in real time.

In some embodiments, the mixed reality tool may identify a digital code associated with a physical item; request access to data associated with the digital code via the physical item; determine metadata associated with a user attempting to access the data associated with the digital code via the physical item; verify the metadata associated with the user via a multi-factor authentication module, wherein the multi-factor authentication module may refer to a mixed reality tool; and manipulate the data associated with the digital code via the physical item in response to a verification of the metadata.

In some embodiments, the mixed reality tool may initiate an operation via a login button, where a user inputs a username and password. In some embodiments, a verification of the user input may be performed by comparing the user input to a user database, where the user database may store the user input and may be updated at a later period of time. Once the verification of the user input is performed, a main mixed reality scene may be generated for the mixed reality tool. In certain embodiments, the main mixed reality scene may utilize the user information to display an interface that provides access to the main mixed reality scene, where the main mixed reality scene includes a verify button, a view button, a modify button, and an administration panel. In certain embodiments, the verify button may provide access to a verification panel in response to a user interacting with the verify button, where the verification panel provides relevant data to the user when the NFC tag is scanned within the mixed reality tool. In certain embodiments, the verification panel may modify code data to be verified in response to the user interacting with the verification button subsequent to the scanning of the NFC tag. In some embodiments, the verification panel with the modified code data is fed into a code database. In some embodiments, the view button may provide access to a show view panel in response to the user interacting with the view button, where the view panel provides relevant data to the user when the NFC tag is scanned within the mixed reality tool. In certain embodiments, the view panel may modify code data to be verified in response to the user interacting with the view button subsequent to the scanning of the NFC tag. In some embodiments, the view panel with the modified code data is fed into the code database. In some embodiments, the modify button may provide access to a modification panel in response to a user interacting with the modify button, where the modification panel provides relevant data to the user when the NFC tag is scanned within the mixed reality tool. In certain embodiments, the modification panel may modify code data associated with a set of input field values in response to the user interacting with the modify button subsequent to the scanning of the NFC tag. In some embodiments, the modification panel with the modified code data is fed into the code database. In some embodiments, the administration panel may retrieve a list of filtered data and refreshed data from the user database. In some embodiments, the administration panel may write an NFC button in response to the device is NFC compatible. In some embodiments and writing the NFC button, the administration panel may write data to the NFC tag. In some embodiments, the user may refresh each button to update each panel with the modified data in response to storing the modified code within the code database. In certain embodiments, the modification of the code may allow a user to stop, start, skip, fast forward, and rewind any of the mixed reality content within the mixed reality tool. In certain embodiments and based on the amount of modification capable while providing flexible mixed reality content, the mixed reality tool may refer to a portable, miniaturized streaming platform that is able to provide mixed reality content.

In some embodiments, the user input may refer to information and/or metadata associated with the user. In some embodiments, the mixed reality tool 103 may utilize a plurality of machine learning modules and artificial intelligence modules to predict behavioral patterns associated with the user based on the metadata of the user. In certain embodiments, the mixed reality tool 103 may generate personalized mixed reality content based on the output of the machine learning modules and artificial intelligence modules. In certain embodiments, the usage of the item associated with the digital code may further affect the metadata associated with the user. In some embodiments, the plurality of administrators may refer to a plurality of clients associated with the mixed reality tool, as each administrator may subscribe to a predetermined threshold of access to provide access associated with the mixed reality content to the plurality of users via the mixed reality tool.

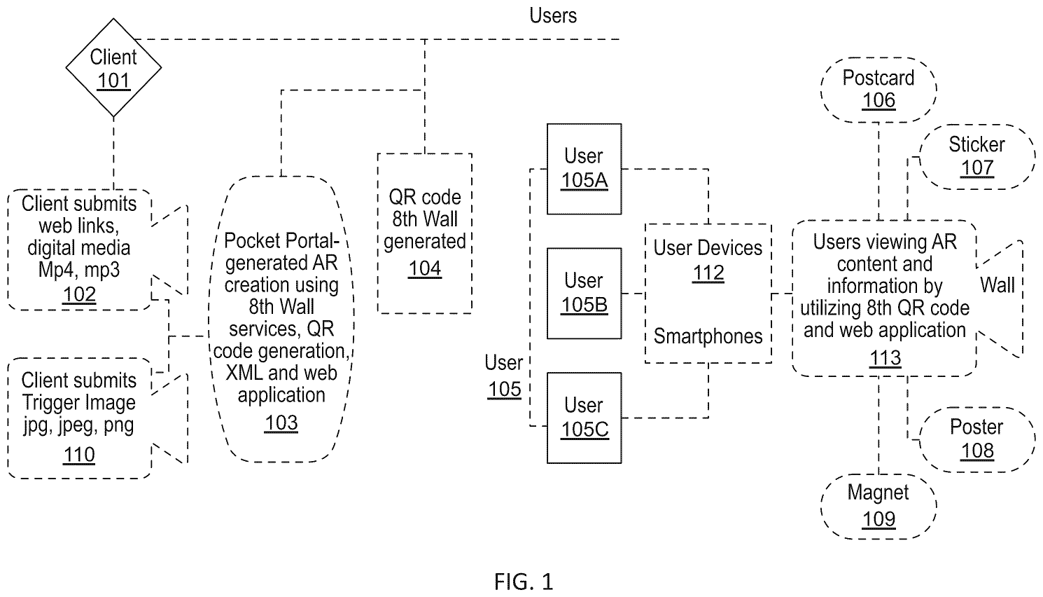

FIG. 1 is a block diagram 100 of an environment where the client 101 may submit all necessary digital media content 102 and the trigger image 110 required for the creation augmented reality poster and sticker application to the mixed reality tool 103. The digital media content 102 may refer to web links, digital media, mp4 and mp3 data. In some embodiments, the trigger image 110 may refer to image data that includes jpg, jpeg, and png data. The mixed reality tool 103 may utilize generated AR creation using a particular web application service, QR code generation, and XML data. In some embodiments, the QR code 104 generated via the particular web application is utilized by the mixed reality tool 103. FIG. 1 also illustrates the environment where the Client 101 may be reached by the user 105A, user 105B and user 105C using their own mobile device 112 to view the mixed reality tool 103 through a web application 113. In some embodiments, the web application 113 may include a postcard 106, a sticker 107, a poster 109, and a magnet 109.

In some embodiments, the mixed reality tool 103 may scan a particular quick response digital code 104 using a device 112 associated with a user 105 of a plurality of users; access, in response to scanning the digital code 104, a camera application associated with the device 112 based on a prompt to the user 105; performing an authentication step to verify identity of the user 105 and the device 112, where the authentication step includes a prompt for a system generated password; triggering, in response to the performing of the authentication step, an action of an mixed reality tool 103 based on the device hovering over a chosen image; and generating augmented reality content utilizing a particular web application based on the particular digital code 104.

In some embodiments, the mixed reality tool 103 may include infinite capacity, compelling as a physical comic and can be physically used to access non-comic book activities, such as events. In some embodiments, the mixed reality tool 103 may allow the user to experience the comic in a constantly changing presentation; access exclusive daily changing offers within the comic, such as meet and greets within the comic; and provide additional resale value overtime. In some embodiments, the mixed reality tool 103 may provide optimized functionality to the user via a collectable marketing tool; a streaming service, live meet and greet platform; event ticket; and/or a security tool that indicates ownership. In some embodiments, the mixed reality tool 103 may allow a user to purchase additional resources virtually via an external database that serves as an online storefront. In some embodiments, the mixed reality tool 103 may consume 78% less paper and request no additional plastic storage, which optimizes a carbon footprint of the present disclosure. In some embodiments, the mixed reality tool 103 may provide a free marketing platform to target users that display tangible interest into an affiliated product and services via a unique hyperlink that bypasses retail stores. In certain embodiments, the mixed reality tool 103 may become part of a resell culture for a discounted or enhanced price, which can flood the market with lightly used second-hand comics.

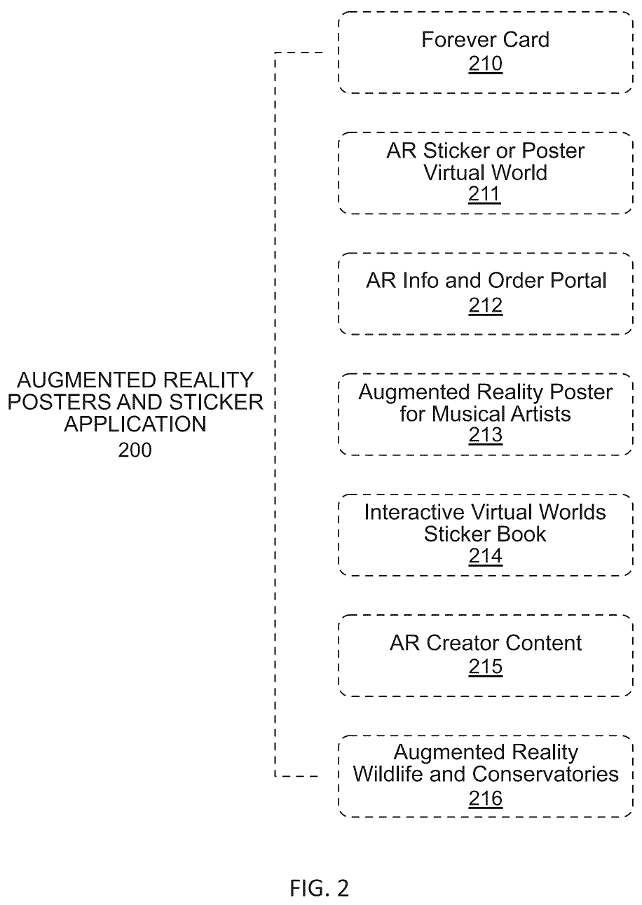

FIG. 2 depicts an augmented reality poster and sticker application 200 via the mixed reality tool 103, in accordance with one or more embodiments of the present disclosure. In some embodiments, the mixed reality tool 103 may include a forever card 210, an AR Sticker and Poster Virtual world 211, an AR Info and Order Portal 212, an AR Poster for Musical Artists 213, an Interactive Virtual Worlds Sticker Book 214, an AR Creator Content 215 and an AR Wildlife and Conservatories 216. In some embodiments, the Forever Card 210 is a continuous augmented reality reusable programmable greeting card. In some embodiments, the AR Sticker Virtual World and Poster Virtual World 211 is an ever-growing augmented reality environment that contain virtual worlds within a sticker 107 or poster 108. In some embodiments, the AR Info and Order Portal 212 is an augmented reality stickers 107, posters 108 or magnets 109 of live programmable animated representation of the client 101. In some embodiments, the Augmented Reality poster for musical artists 213 is a poster 108 that displays an updated tour schedule of musical performances that is broadcasted live to the actual poster 108. In some embodiments, the AR Wildlife and Conservatories 216 may refer to an augmented reality poster 108 and stickers 107 that display digital media 102 of a live feed of wildlife or zoo exhibits with a web portal to allow donations and the purchase of merchandise Each of these serves as separate portals within the exemplary augmented tool 103 and may communicate with each other to provide real-time augmented reality data. Referencing FIGS. 2-9 of the mixed reality tool 103 may supply a user with the web generated QR code 104 to be given back to client 101 to distribute to users 105.

In some embodiments, the exemplary mixed reality tool 103 may generate augmented reality creations that can be used by Individuals, Family Group, On Behalf of Others, Religious Organizations, Social Organizations, Businesses, Sport Organizations and Education Institutions, for example.

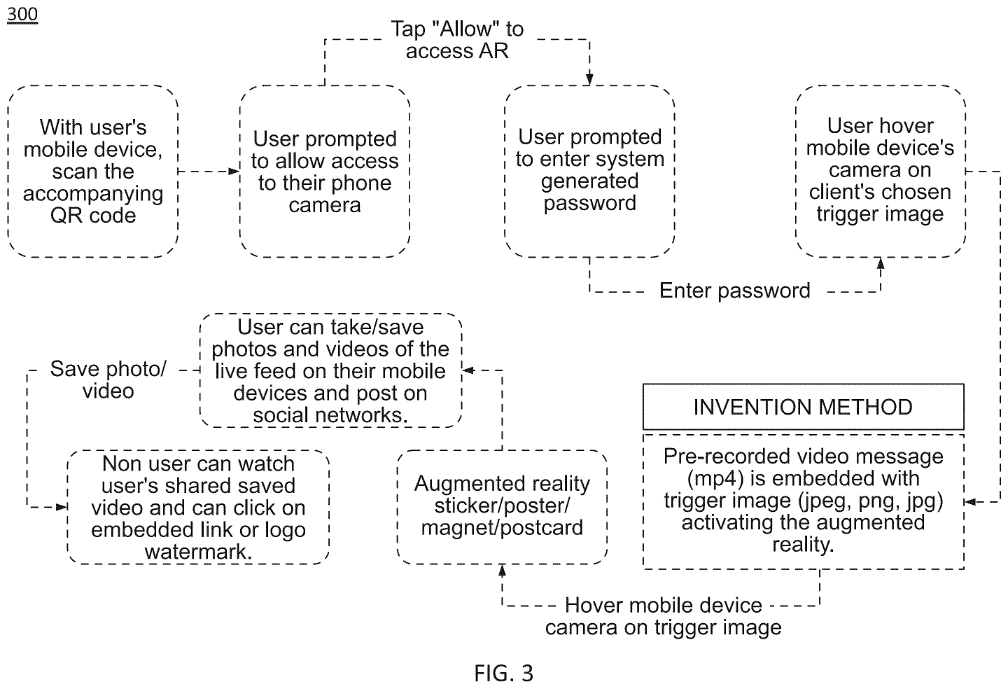

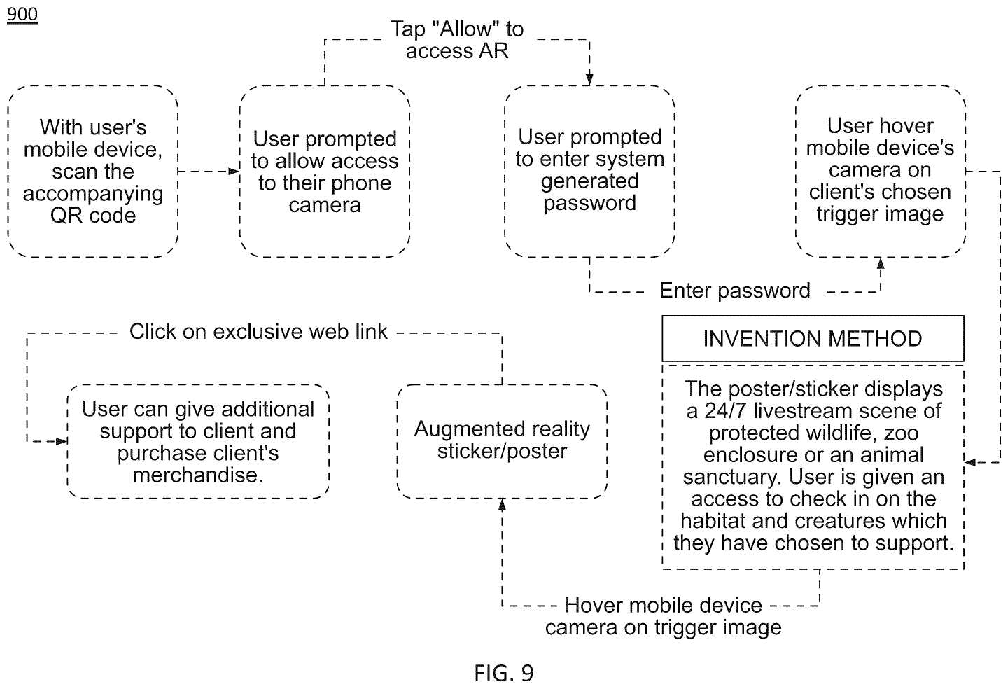

FIG. 3 thru FIG. 9 shares the same sample process of accessing the AR. In some embodiments and using the mobile device 112, the user 105 can scan the QR code 104 that accompanies printout material purchased or given from the client 101. In some embodiments, the user 105 may be prompted to allow access to their smart phone 112 camera and may be prompted to enter a system generated password that enhances the exclusivity of the product. In certain embodiments, non-users may be able to acquire passwords when they purchase printout materials from a particular client 101. In some embodiments, the user 105 can hover the mobile device 112 on a client's chosen trigger image 110.

FIG. 3 is a flow diagram 300 of an example process for viewing Forever Card 210, in accordance with one or more embodiments of the present disclosure. The Forever Card 210 may refer to a continuous augmented reality reusable programmable greeting card. In certain embodiments, the birthday or any annual cards that celebrate your birthday every year or any annual event. In some embodiments, the digital media 102 of a pre-recorded video message is embedded on the trigger image 110 based on activating the mixed reality tool 103. In some embodiments, the user 105 can store photos and videos of the live feed on the smart phone 112 and post on social networks at discretion. In some embodiments, the non-user can watch the shared saved video of the user 105 and can interacted with an embedded link or logo watermark. In some embodiments, the client 101 can input a plurality of greetings, cued up to several dates for a set number of occasions that plays on those selected dates.

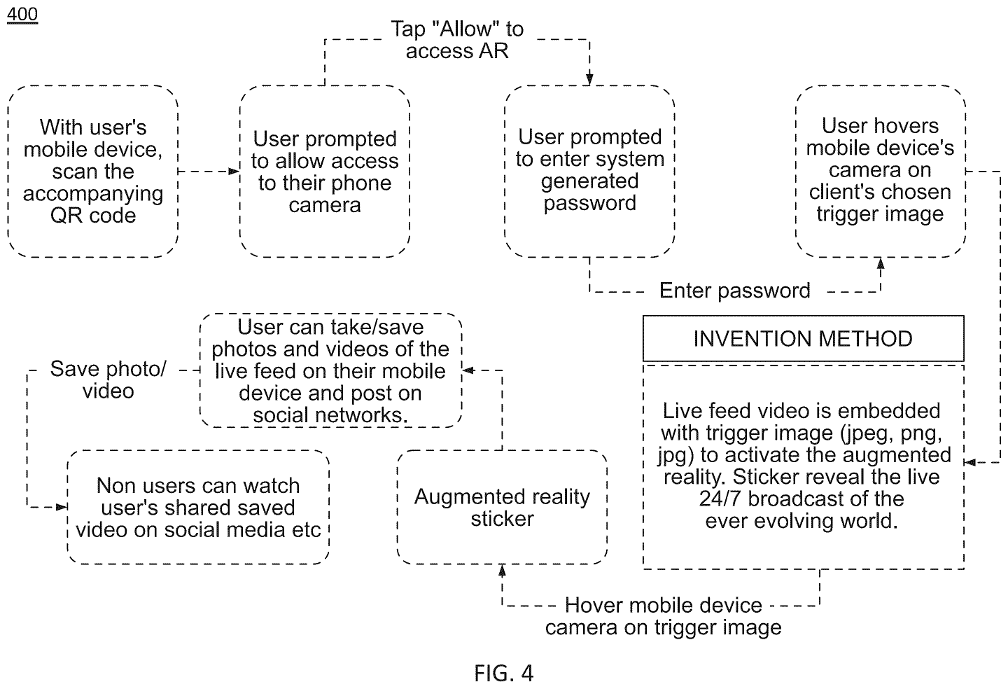

FIG. 4 is a flow diagram 400 of an example process for viewing the AR Sticker Virtual World and Poster Virtual World 211, in accordance with one or more embodiments of the present disclosure. In some embodiments, the AR Sticker Virtual World and Poster Virtual World 211 may refer to an augmented reality ever growing virtual worlds within a sticker 107 or poster 108. In some embodiments, the digital media 102 of a live feed video that is embedded with the trigger image (jpeg, png, jpg) 110 to activate the augmented reality. In some embodiments, the sticker 107 may reveal the live broadcast of the virtual environment. In some embodiments, the mixed reality tool 103 may generate the augmented reality sticker 107 in response to the live video being embedded. In some embodiments, the user 105 can save photos and videos of the live feed on the smart device 112 and post on the social network of the user 105. In certain embodiments, the non-user can watch the shared saved video on social media of the user 105.

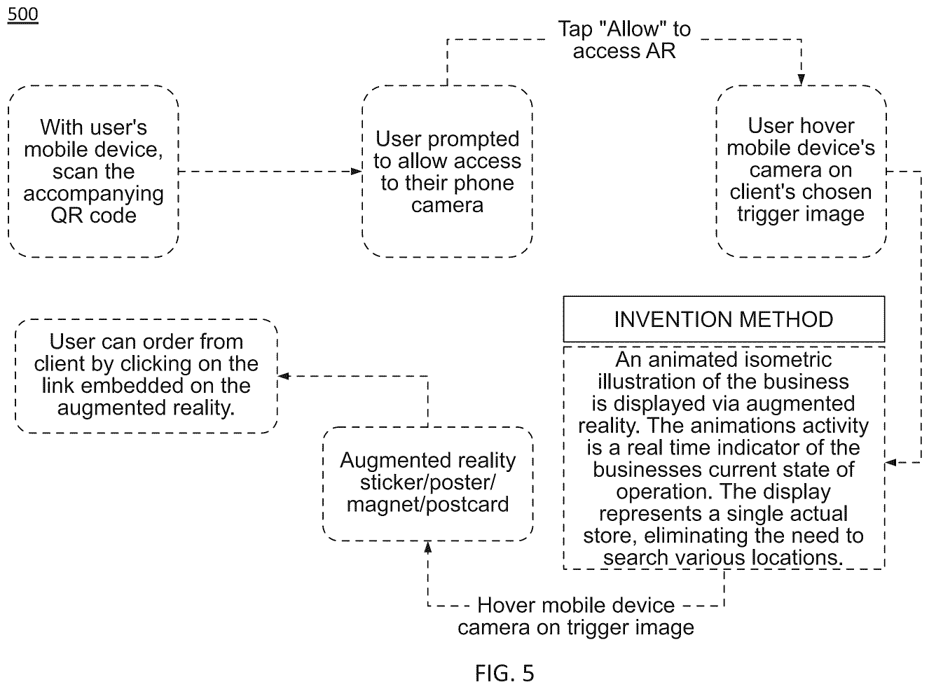

FIG. 5 is a flow diagram 500 of an example process for viewing AR Info and Order Portal 212, in accordance withgone or more embodiments of the present disclosure. In some embodiments, the AR Info and Order Portal 212 is an augmented reality stickers 107, posters 108 or magnets 109 of live programmable animated representation of the client 101 as establishments containing an ordering portal. In some embodiments, the AR Info and Order Portal 212 may refer to an animated isometric illustration of the business that can be displayed via augmented reality. In certain embodiments, the animations activity may refer to a real time indicator of the businesses current state of operation. The display may represent a single actual store, eliminating the need for the client 101 to search a plurality of various locations. In some embodiments, the mixed reality tool 103 may generate the augmented reality sticker 107, poster 108, postcard 109 and magnet 110. In some embodiments, the user 105 can order from client 101 by clicking the link embedded on the mixed reality tool 103. In certain embodiments, the augmented reality display may serve as a hyperlink directly to the businesses online sales and can encode for discounts and promos.

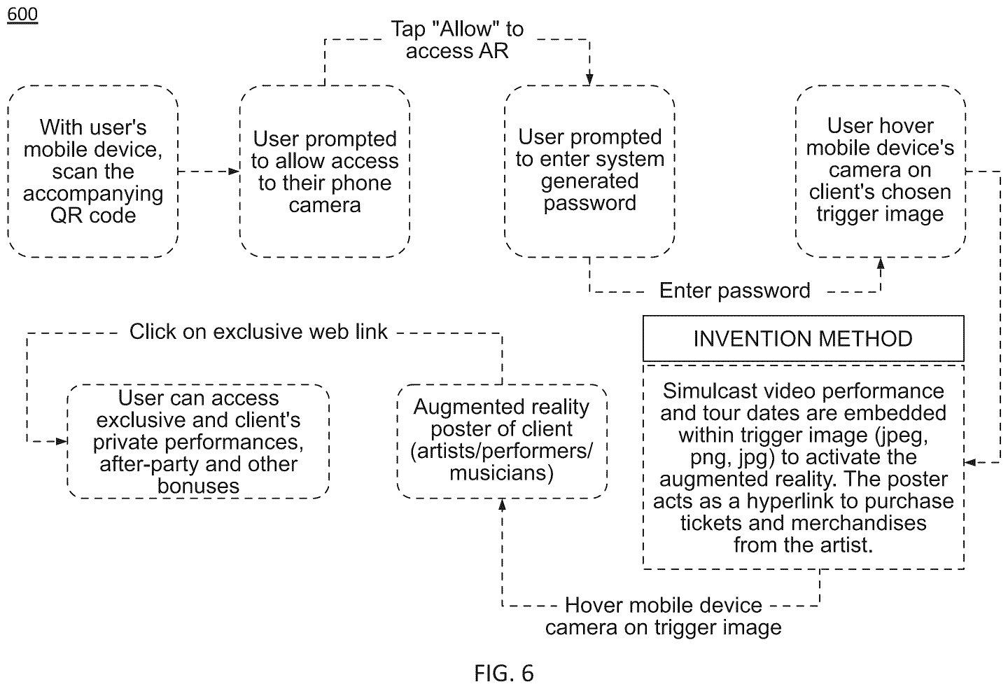

FIG. 6 is a flow diagram 600 of an example process for viewing Augmented Reality poster for musical artists 213, in accordance with one or more embodiments of the present disclosure. In some embodiments, the Augmented Reality poster for musical artists 213 is a poster 108 that displays an updated tour schedule of musical performances that is broadcasted live to the actual poster 108. In some embodiments, the simulcast video performance and tour dates are embedded within the trigger image 110 to activate the mixed reality tool 103. In certain embodiments, the poster 108 may act as a hyperlink to purchase tickets and merchandise from the artist. In some embodiments and in response to the activation of the mixed reality tool 103, the user 105 may grant exclusive access to the client 101 artist and their brand. In some embodiments, the mixed reality tool 103 may generate the augmented reality poster of client that includes artists, performers, and/or musicians. In some embodiments and in response to interacting with the exclusive web link, the user 105 can order more items or merchandise associated with other clients through an embedded link within the mixed reality tool 103. In certain embodiments, the augmented reality display may serve as a hyperlink directly to the businesses online sales and can encode for discounts and promos.

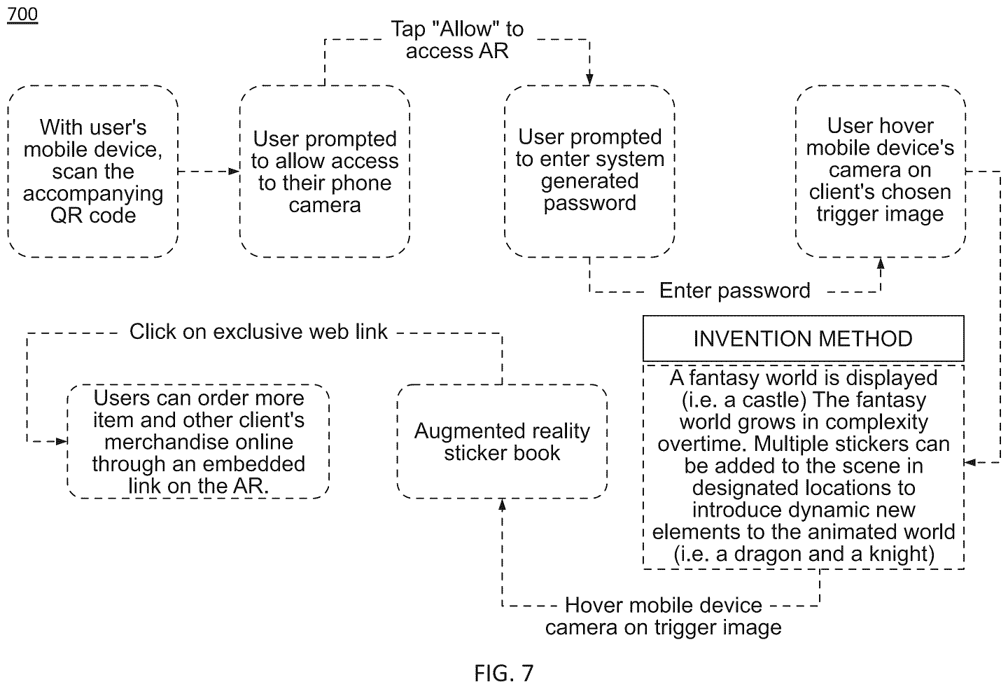

FIG. 7 is a flow diagram 700 of an example process for viewing Interactive Virtual Worlds Sticker Book 214, in accordance with one or more embodiments of the present disclosure. In some embodiments, the mixed reality tool 104 may generate a fantasy world to be displayed. In some embodiments, the fantasy world may allow the client 101 to add stickers 107 that influence the outcome of their continuous updated animated virtual world. In certain embodiments, the mixed reality tool 104 may show the fantasy world that grows in complexity over time. In some embodiments, the sticker 107 can be added to the scene in designated locations to introduce dynamic new elements to the animated world (i.e. a dragon and a knight). In some embodiments and in response to generating the fantasy world, the mixed reality tool 103 may generate the augmented reality sticker book. In some embodiments, the user 105 can order more items and other merchandise associated with other clients online through an embedded link within the mixed reality tool 103. In certain embodiments, a choose-your-own adventure sticker book unfold in new and unpredictable ways in a constantly playing and evolving virtual environment.

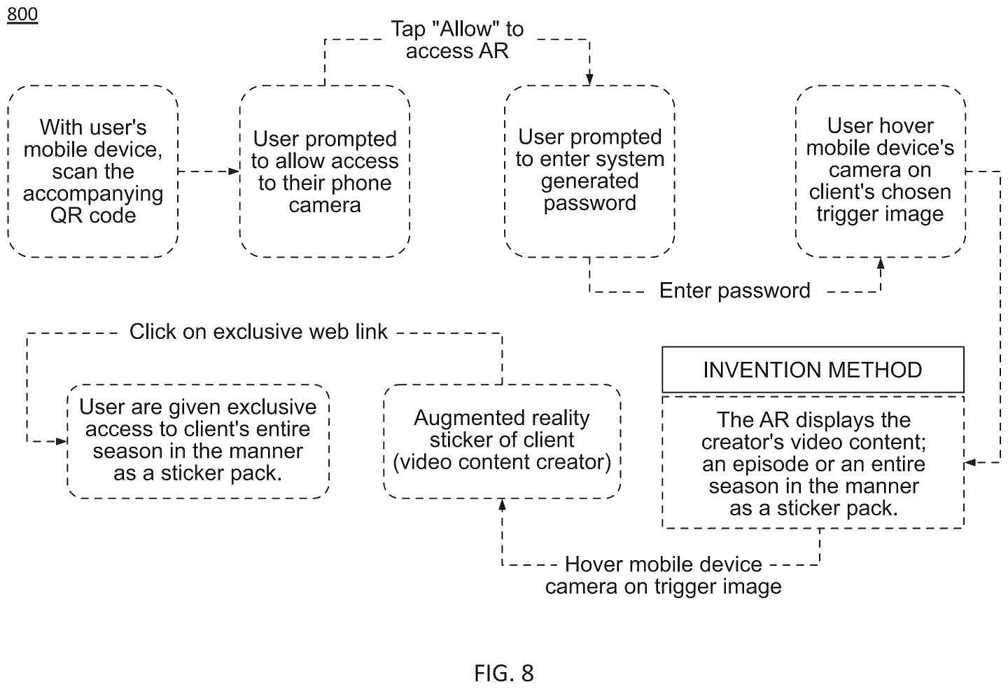

FIG. 8 is a flow diagram 800 of an example process for viewing AR Creator Content 215, in accordance with one or more embodiments of the present disclosure. In some embodiments, the augmented reality sticker/flyer that encodes the digital media 102 creator content (i.e. episodes) as a direct-to-consumer method of distributing video content. In some embodiments, the mixed reality tool 103 may display the video content such as an episode or an entire season in the manner as a sticker pack 107. In some embodiments, the mixed reality tool 103 may generate the augmented reality sticker of the client 101 such as a video content creator. In some embodiments and in response to the client interacting with the exclusive web link, the user 105 may be given exclusive access to an entire season associated with the client 101 in the manner as a sticker pack 107.

FIG. 9 is a flow diagram 900 of an example process for viewing AR Wildlife and Conservatories 216, in accordance with one or more embodiments of the present disclosure. In some embodiments, the augmented reality poster 108 and stickers 107 may display digital media 102 of a live feed of wildlife or zoo exhibits with a web portal to allow donations and the purchase of merchandise. In some embodiments, the rescue, charities, and wildlife conservationist may refer to a particular client 101 capable of selling posters 108 of animals and habitats. In some embodiments, the posters 108 allow the users 105 to view these animals and habitats live 24/7 from anywhere in the world. In some embodiments, the user 105 is given access to monitor the creatures in which each user 105 has chosen to support. In some embodiments, the mixed reality tool 103 may generate the augmented reality sticker 107 and poster 108. In some embodiments and in response to the client 101 interacting with a web link, the user 105 can give additional support to the client 101 and purchase merchandise associated with the client 101.

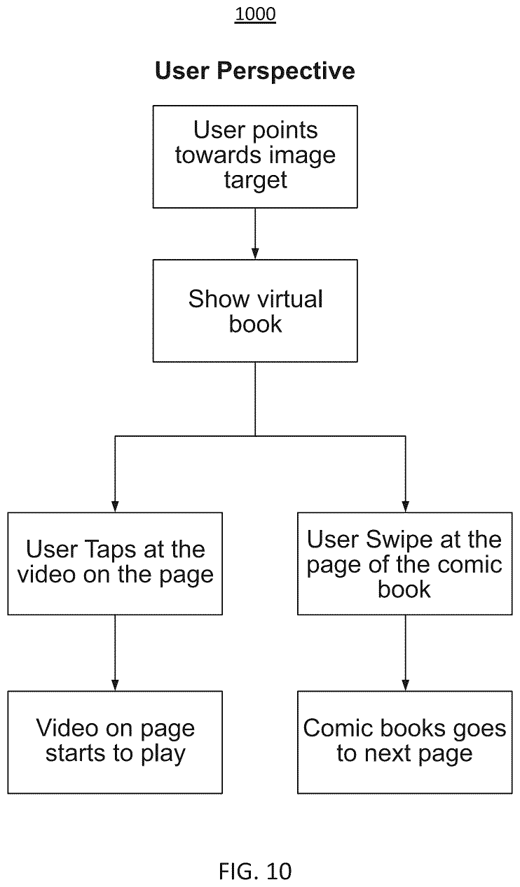

FIG. 10 is a flow diagram 1000 of the mixed reality tool from a user perspective, in accordance with one or more embodiments of the present disclosure. In some embodiments, the mixed reality tool 103 may initiate when the user points the computing device towards the image target. In some embodiments and in response to the user pointing the computing device towards the image target, a virtual book is displayed via the interface. In some embodiments, the user may interact with the virtual book to initiate a mixed reality content and/or swipe through a plurality of pages stored within the virtual book. In certain embodiments, the user may initiate a video to play via the interface of the computing device. In certain embodiments, the user may cause the virtual book to move to a different page. While various embodiments have been described above, it should be understood that they have been presented by way of example only, and not limitation. For example, any of the elements associated with mobile device implement systems and method including augmented reality may employ any of the desired functionality set forth herein above. Thus, the breath and scope of a preferred embodiment should not be limited by any of the above-described exemplary embodiments.

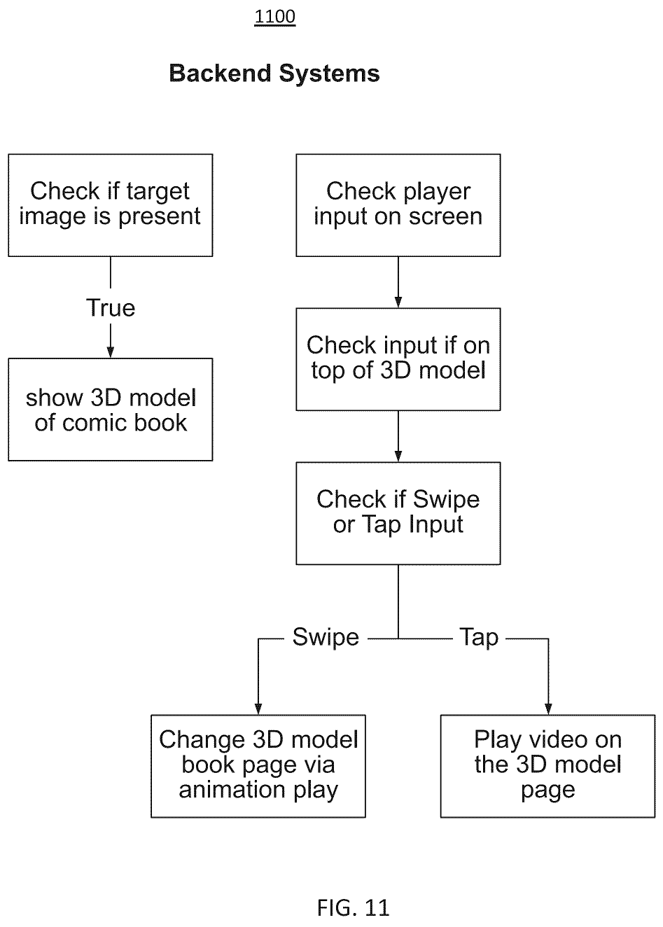

FIG. 11 is a flow diagram 1100 of the mixed reality tool from a backend system perspective, in accordance with one or more embodiments of the present disclosure. In some embodiments, the mixed reality tool 103 may verify that the target image is present. In some embodiments and in response to verifying that the target image is present, the mixed reality tool 103 may generate a 3D model of the mixed reality content. In some embodiments, the mixed reality tool 103 may verify that player input is present. In some embodiments, the mixed reality tool 103 may verify the player input once placed at the top of a 3D model. In certain embodiments and once the multi-factor verification is performed, the mixed reality tool 103 may determine a type of user input, where the type of user input may refer to a tap or a swipe via haptic sensors of the computing device. In some embodiments, the mixed reality tool 103 may provide a video on the 3D model page within the interface in response to the tap and may provide a change within the 3D model book page via an animation player in response to the swipe. While various embodiments have been described above, it should be understood that they have been presented by way of example only, and not limitation. For example, any of the elements associated with mobile device implement systems and method including augmented reality may employ any of the desired functionality set forth herein above. Thus, the breath and scope of a preferred embodiment should not be limited by any of the above-described exemplary embodiments.

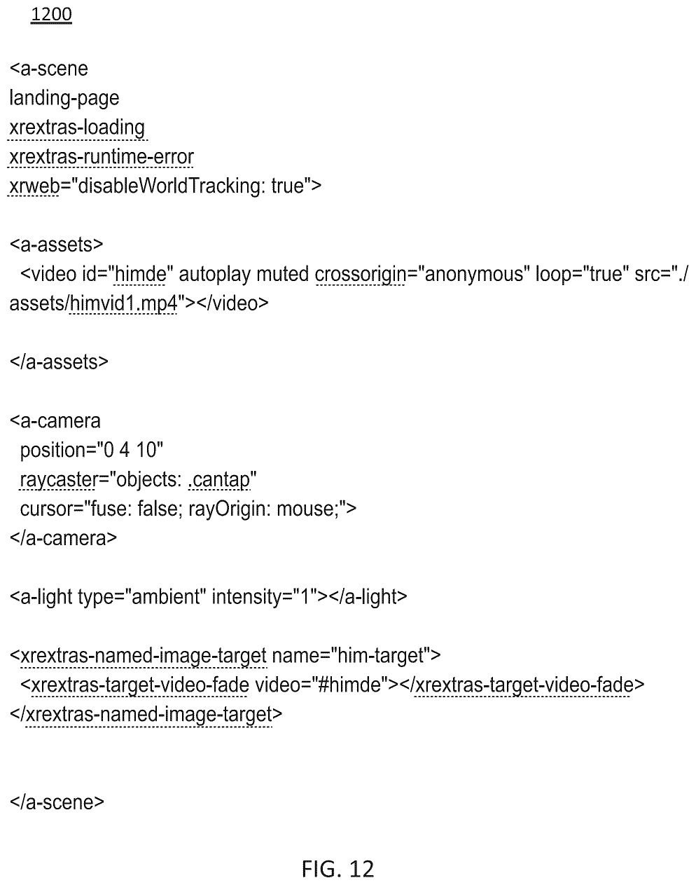

FIG. 12 illustrates the sample HTML code 1200 that activates the mixed reality tool 103, in accordance with one or more embodiments of the present disclosure. In some embodiments, the sample HTML code 1200 depicts a scene, landing page, with the extras and an element of the disabling world tracking. Within the code, there exists an element of assets that include a video id that allows for autoplay of muted cross origin. Within the code, the camera has position and cursor elements that provide light type and ambient intensity.

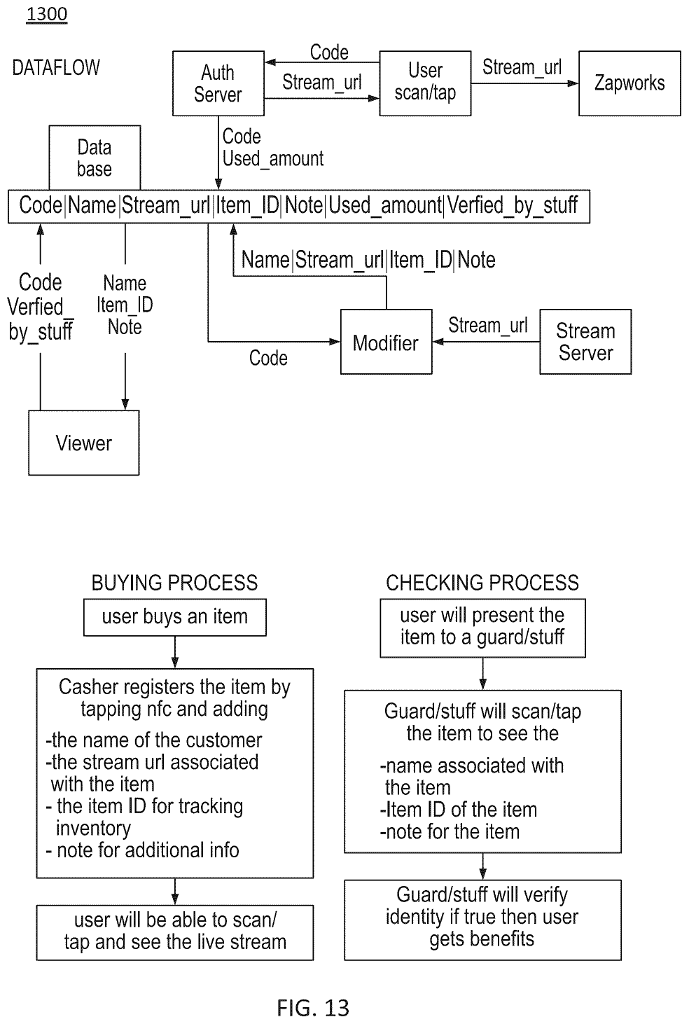

FIG. 13 is a flow diagram 1300 of an exemplary process for viewing mixed reality data, in accordance with one or more embodiments of the present disclosure. In some embodiments, the mixed reality tool 103 may retrieve the mixed reality data from the database to display via an interface within the viewer. In some embodiments, the code associated with the mixed reality data may be modified within the modifier and then transmitted and stored within an authentication server. In certain embodiments, the modifier may pull additional data from a stream sever to aggregate to the mixed reality data in the modifier prior to the data being stored in the authentication server. In some embodiments, the user input (i.e., scan and/or tap) may serve as a modification to the code or an authentication step to access the mixed reality data. In some embodiments, the code may be modified in response to the user purchasing an item, either physically and/or digitally. In certain embodiments and in response to the user purchasing the item, a cashier may register the item by tapping a NFC chip associated with the mixed reality tool 103 and adding new code to modify the existing code, where the new code may include the name of the user, the stream URL associated with the item, the item ID for inventory tracking, and any other additional information associated with the item. In some embodiments, the mixed reality tool 103 may access additional mixed reality code as a result of the modified code associated with the purchase of the item. In certain embodiments, a similar modification may occur if a user verifies the modified code associated with the purchase of the item via an authentication scan of the item to verify the name associated with the item and the item ID and compare that information with the information stored on the mixed reality tool 103.

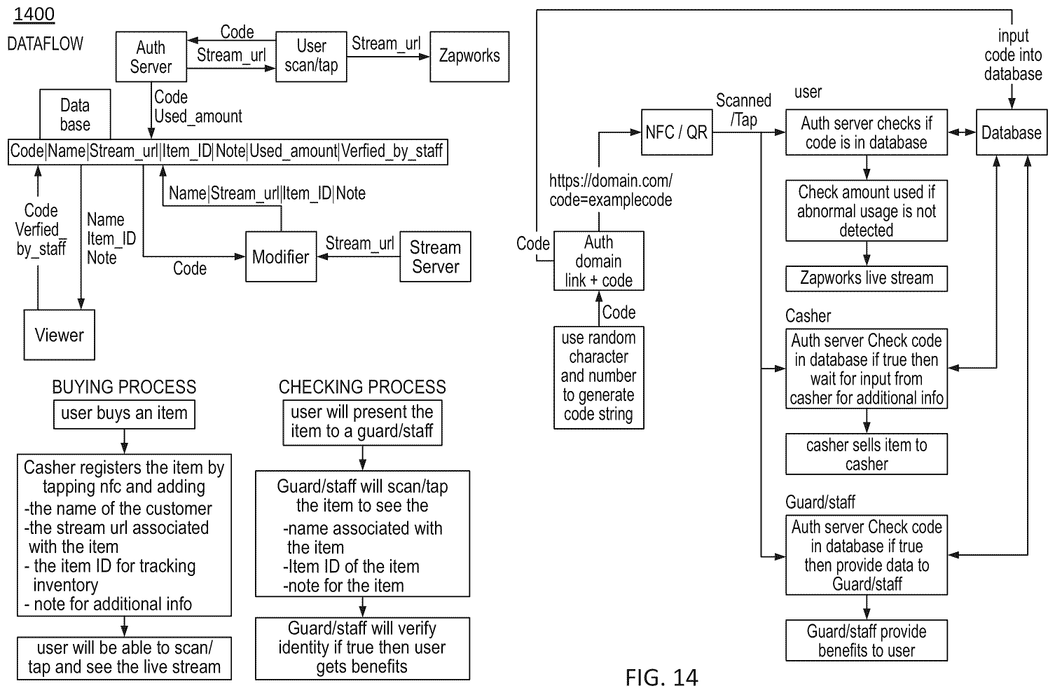

FIG. 14 is a flow diagram of an exemplary process for interacting with mixed reality data, in accordance with one or more embodiments of the present disclosure. In some embodiments, the mixed reality tool 103 may interact with a digital code, either NFC code and/or QR code. In certain embodiments, the digital code is generated via a plurality of random characters and numbers to generate a code string. In certain embodiments and in response to the code string being generated, an authentication domain link and code may be generated and stored in a database for subsequent interaction. In some embodiments, the authentication server may verify the digital code is stored in the database. In some embodiments, the authentication server may calculate usage associated with the digital code to determine whether the calculated usage exceeds an abnormal usage threshold. In some embodiments and in response to determining the calculated usage associated with the digital code does not exceed the abnormal usage threshold, the mixed reality tool 103 may provide access via an interface to a mixed reality data live stream. In some embodiments, the digital code may be verified by the authentication server in response to a casher selling an item with access to additional mixed reality data to the user and/or in response to a guard providing a benefit associated with the digital code to the user.

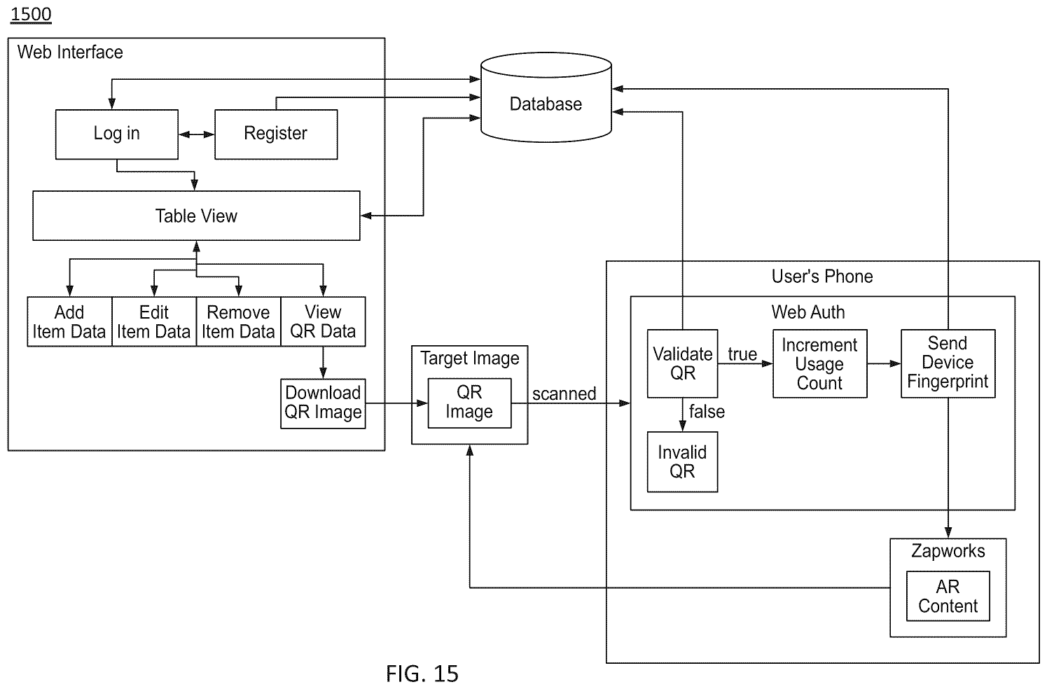

FIG. 15 is a flow diagram 1500 of an exemplary process of communication between a web interface and a computing device interacting with mixed reality data, in accordance with one or more embodiments of the present disclosure. In some embodiments, the mixed reality tool 103 may be stored within a mobile computing device of the user and may scan a digital code associated with a target image. In certain embodiments, the digital code associated with the target image may refer to a QR code. In some embodiments and in response to scanning the digital code, the mixed reality tool 104 may validate the digital code to provide access to the mixed reality content. In certain embodiments, the validation of the digital code may result in increasing an increment usage count associated with the digital code and prompt an authentication step for the user to perform using the computing device. For example, the prompt for the authentication step may refer to a double tap with an interface, a swipe, or a biometric scan of the user. In certain embodiments, the mixed reality tool 103 may be unable to validate the digital code associated with the target image and invalidate the digital code. In some embodiments and in response to accessing the mixed reality content, the mixed reality tool 103 may store the digital code within a database. In some embodiments, a web interface communicates with the database that stores the digital code, which allows for the generation of subsequent digital codes associated with the target image. In certain embodiments, the web interface generated the subsequent digital codes by verifying information via login and registration. In some embodiments and in response to verifying information, a user may manipulate the mixed reality content associated with the digital code via a table view, where the user may add item data, edit item data, remove item data, and view the current digital code. In response to the manipulation of the mixed reality content, a new digital code may be generated for the target image.

In some embodiments, the mixed reality tool 103 may include a plurality of modules to perform a plurality of capabilities, such as presented an augmented reality for comic books in a postcard; an augmented reality in children's books; an augmented reality enabled wearable with NFC chips embedded in a rubberized patch; a music concert poster; a conservation poster; wall decals; trading cards; sticker book with real-time embedded triggers; live displays; and augmented reality packing for commemorative collectables. For example, the mixed reality tool 103 may refer to a postcard with an embedded NFC chip or QR code created using exemplary methodology that allows users to upload full length animations of their comic within the tool with a looping functionality. In this example, a video pause and play control feature may be included or can be a close system looping or with control play buttons or can be a programmable broadcast capable of hosting livestreams from the creator to their customers via a unique hyperlink that further allows the user to touch a display screen to access exclusive content and websites that can be embedded with functional data. In another example, the mixed reality tool 103 may include access to a release event for a single comic book within a postcard or use the postcard to release several animated comic releases on a predetermined schedule directly to the customer, thereby turning the mixed reality tool 103 into a miniaturized streaming service with infinitely programmable content. In another example, the mixed reality tool 103 may include a non-fungible token based on creating individual hyperlinks for each print, thereby each postcard can access the broadcast sever via its own QR code, where an NFC chip may be encoded. In this example, the name of the purchaser may be stored in an external authentication application that communicates with an external computing device and allows a cashier to register each individual hyperlink at the time of the purchase within an hour database, where the name of the purchaser may be paired with the purchased individual hyperlink creating a multi-factor authentication module. This multi-factor authentication module allows the mixed reality tool 103 to act as secure passes to real-life events such as book signings, movie premiers, and gatherings. In another example, the mixed reality tool 103 may reduce creator shipping costs and printing costs and create a new experience within the industry.

In another example, the mixed reality tool 103 may refer to a children's book with an embedded NFC or QR code that host infinitely programmable looping media content within its pages or on its cover. In another example, the mixed reality tool 103 may refer to a school textbook that allows known personalities to teach synchronized livestream lessons to entire school districts via an embedded trigger displayed on the textbook cover or on a retro fitted book cover creating a new form of educational presentation by combining the live and virtual presences. In another example, the mixed reality tool 103 may refer to a hosted live nationwide library read-along with celebrity quests on certain evenings, such as a Magic Schoolbus reading from Oprah Winfrey on a 6 pm on Friday via the embedded trigger associated with the augmented reality display within the book cover. In another example, the mixed reality tool 103 may refer to an enabled wearable that provides an enabled patch to reveal an augmented reality video play on a back or front panel. In another example, the mixed reality tool 104 may refer to the enabled wearable that includes an embedded NFC chips via rubberized patches that act as an interactive experience for theme parks and live action role play, such as a Harry Potter shirt that displays an augmented reality map for in-park easter egg hunts and secret missions. In another example, the mixed reality tool 103 may refer to the enhanced wearable capable of acting as a pass to a real-life event such as movie premiers and social gatherings via the multi-factor authentication module, where owners of the enhanced wearable may log their identification into a database for third parties such as guards, ticket merchants, and cashiers to scan the squire unique hyperlink and request a matching identification to facilitate a trackable purchase or entry. In another embodiment, the mixed reality tool 103 may refer to a wearable that can contain augmented reality programming that precisely match a time zone any day of the year and displays a timed broadcast of programming that was playing on the television network during the exact time during the particular year associated with the wearable. In some embodiments, the mixed reality tool 103 may refer to a music concert poster embedded with an NFC or QR code that can be sold in advance of an upcoming musical concert tour. When the user activates the augmented reality experience within the poster, the user may view looping exclusive content from that artist, where the exclusive content may include tour's schedule and unique hyperlinks that allow one to buy merchandise and tickets. In another example, the mixed reality tool 103 may allow a viewer to watch a livestream view of an actual concert from a predetermined price tiered seating.

In another embodiment, the mixed reality tool 103 may include a ticket and lanyard embedded with the NFC or QR code that can be sold in advance of an upcoming musical concert tour. In this example, the lanyard and tickers may perform an extra functionality of hosting live vlogs of the artist or performs arriving to stage, which allows a plurality of users in attendance at the venue to wear or hold a window into the artist's arrival process. This would allow an owner to know exactly when Beyonce will take the stage because there has been a camera following her since the earlier dress rehearsal that day, and that feed is only shared to privilege few users. In another embodiment, the mixed reality tool 103 may include a poster or wall decal with an embedded NFC chip or QR code that displays a continuous live stream of the wilderness, landscape or animal containment, where this may be directed toward zoos and wildlife sanctuaries. In this example, the mixed reality tool 103 may include a renewal of access to the continuous wilderness viewership that can be paid thru the hyperlink to be able to sell access to protected creatures and lands without distributing habitants or animal behavior. In another example, the mixed reality tool 103 may refer to a trading card with an embedded NFC chip or QR code that displays a continuous livestream or looping content to provide a window for collectors. In another example, the mixed reality tool 103 may embed an experience of unlimited practice footage of an athlete, exclusive interviews, and livestream meet and greets within the card. In another example, the mixed reality tool 103 may refer to a card representing characters and game items and places that can be revealed as hours of looping wildlife and landscape of the fictional world that can reveal battles or living within their home environments with unlimited simulcast broadcast capability. In another example, the mixed reality tool 103 may include a unique hyperlink that can provide non-fungible access to a real-life experience, such as a voucher to receive new packs at participating retailers.

In another example, the mixed reality tool 103 may refer to a sticker book with an embedded NFC chip or QR code that displays a continuous livestream or looping content, where each page of the book may display a different fantasy game or photograph, giving the illusion that the world is real. Provided stickers can be placed in predetermined outline areas, where the user may alter a target image and subsequently experience a slightly different version of the world based on modified, added physical elements. In another example, the mixed reality tool 103 may include a simulcast broadcast of a continually looped experience, where the combination of stickers can unlock a plurality of hidden reality timelines within one sticker book page. In another example, the mixed reality tool 103 may include a live display based on a restaurant flyer, magnets, and in-store displays with an embedded NFC chip or QR code, The live display may refer to an image of a cartoon Pizza Hut, where the animated store is a real time program providing a one-to-one representation of the business status of the Pizza Hut. In another example, the mixed reality tool 103 may refer to an augmented reality packaging for commemorative collectible with an embedded NFC chip or QR Code displays a continuous livestream or looping content and display many documentaries of creation hosted by the creator.

In some embodiments, the Augmented reality (AR) and virtual reality (VR) methods that leverage the capabilities of the smart device 112 to deliver AR or VR experiences. In some embodiments, mixed reality tool 103 may involve integrating sensors, cameras, and software algorithms to overlay virtual content onto the real world or create immersive virtual environments. In some embodiments, a plurality of mobile payment systems associated with the developing and implementing methods for mobile payments, such as mobile wallets or payment apps. This involves integrating payment gateways, ensuring secure transactions, and providing a seamless user experience for making payments using mobile devices. In some embodiments, the mixed reality tool 103 may utilize the GPS or other location tracking technologies in the smart device 112 to provide location-specific information or services. This can include mapping applications, navigation systems, location-based marketing and other location-aware functionalities. In some embodiments, the mixed reality tool 103 may develop and implement methods to secure smart device 112 from various threats, such as malware, unauthorized access, or data breaches. This can involve encryption techniques, biometric authentication, secure data storage, and remote device wipe capabilities. These are just a few examples of mobile device implemented methods. The field of mobile technology is rapidly evolving, and new methods are constantly being developed to enhance the functionality, performance, and user experience on mobile devices.

In some embodiments, the mixed reality tool 103 may generate mixed reality content associated with a global simulcast, where the global simulcast may refer to a universal broadcast that reaches a plurality of users at the same time with the same mixed reality content without regional delays. In certain embodiments, the current augmented reality content may include short video clips that cannot play independently but can only initiate when a user interacts with the content, interface and/or device. Moreover, current augmented reality content is unable to separate live broadcast from video clips. In some embodiments, the mixed reality tool 103 may generate the mixed reality content that include live broadcasts, still images, and pre-recorded video without any additional action from the user. In certain embodiments, the mixed reality tool 103 may refer to a streaming service capable of initiation from a sweatshirt and/or a television network capable of initiation from a sticker.

In some embodiments, the mixed reality tool 103 may generate mixed reality content that integrates a plurality of media types into a single form of content. Specifically, the mixed reality content may include live and recorded feeds. For example, the mixed reality tool 103 may provide live mixed reality content while pausing that live mixed reality content to provide pre-recorded mixed reality content, such as a breaking news segment on a live broadcast. This ability to provide live and pre-recorded feeds also increases the scalability associated with the mixed reality content. Specifically, current augmented reality content provides short videos and any video requiring storage that exceeds a predetermined threshold, the augment reality content offloads the videos onto a third-party platform, where the mixed reality tool 103 provides an interface capable of providing those live streams and pre-recorded short videos, which exponentially increases the scalability of the mixed reality tool 103.

In some embodiments, administrators associated with the mixed reality content may modify the code at any time, allowing administrators (i.e., content distributors) to add new content, edit content, and/or remove content in real-time during a broadcasting loop within the mixed reality content. In certain embodiments, the improved flexibility with the modification of the mixed reality content may allow for simultaneous broadcast and schedule meet and greets with a plurality of users in real-time. Ins some embodiments, the ability to modify the mixed realty content may also provide user-directed advertisements. For example, an exclusive deal only available via the mixed reality tool 103 to a user that interacted with a particular item at a predetermined period of time.

In some embodiments, the mixed reality tool 103 may generate a multi-factor authentication system, where the tool itself may serve as a first authentication factor, an item associated with the target image may serve as a second authentication factor, and a verification of the user associated with the mixed reality tool 103 and verification of usage associated with the item may serve as additional authentication factors. In certain embodiments, this multi-factor authentication process associated with the mixed reality tool 103 may serve as an improvement to current non-fungibility tokens, as the mixed reality tool 103 and digital code associated with the target image stored within the item can be readily verified and tracked to confirm and verify user identity and item usage rates. Moreover, this additional security aspect associated with the mixed reality tool 103 may enhance user experience as it may foster a deepened sense of connection and ownership between the user and the mixed reality content via the mixed reality tool 103.

In some embodiments, the mixed reality tool 103 may implement a system and method for customization of generated content using a device associated with the user. In some embodiments, the mixed reality tool 103 may automatically generate, collect, perform, monitor, analyze, and transmit data elements associated with the plurality of users within an active mixed reality broadcast content and/or mixed reality content in an immersive environment. In one embodiment, the mixed reality tool 103 associated with a user may enter a mixed reality immersive geolocation established by a plurality of sensors around a boundary of the mixed reality immersive area. The user may opt-in and/or opt-out of the access of the mixed reality content in response to a verification of the user identity and the digital code associated with a particular item stored in the mixed reality tool 103. In certain embodiments, the opt selection of the user may be stored in a database for future use within a mixed reality immersive area. In some embodiments, the mixed reality content is available for access to the user via the mixed reality tool 103 in response to the opt-in selection. In some embodiments, the administrator of a plurality of administrators may provide the mixed reality content to perform preferences and/or content verification associated with user input and metadata associated with the mixed reality tool 103. In some embodiments, the mixed reality tool 103 may synchronize a user device based on the mixed reality content provided by the administrator. In some embodiments, the generated mixed reality content may be transmitted to a plurality of mixed reality tools based on the user input of other users within the mixed reality immersive area. In certain embodiments, the transmission of the generated mixed reality content to the plurality of mixed reality tools may be analyzed via an artificial intelligence module to collect and store all or partial data points associated with the mixed reality content, where the mixed reality content may be stored in various formats such as a text file, a still image, a video, a live broadcast, and a rebroadcast. In some embodiments, the mixed reality tool 103 may utilize the collect content to generate modified and personalized mixed reality content directed to the identity of the user.

While one or more embodiments of the present disclosure have been described, it is understood that these embodiments are illustrative only, and not restrictive, and that many modifications may become apparent to those of ordinary skill in the art, including that various embodiments of the inventive methodologies, the inventive systems/platforms, and the inventive devices described herein can be utilized in any combination with each other. Further still, the various steps may be carried out in any desired order (and any desired steps may be added and/or any desired steps may be eliminated).

What is claimed is:

1. A method, comprising:
scanning, by a processor, a particular quick response digital code using a device associated with a user of a plurality of users;
accessing, by the processor and in response to scanning the digital code, an interface associated with the device based on a first prompt to the user;
performing, by the processor, an authentication step to verify identity of the user and the device, wherein the authentication step comprises a second prompt for a unique code;
triggering, by the processor and in response to the performing of the authentication step, an action of a mixed reality tool based on the device hovering over a chosen image; and
generating, by the processor, mixed reality content utilizing a particular application based on the particular digital code.

2. The method of claim 1, wherein the mixed reality content comprises:
a digital postcard,
a digital sticker,
a digital sticker, and
a digital magnet.

3. The method of claim 1, wherein the mixed reality tool comprises a portable streaming service capable of providing the mixed reality content.

4. The method of claim 1, wherein the digital code comprises a QR code associated with a web application.

5. The method of claim 1, wherein the mixed reality content further comprises a pre-recorded video message embedded with the trigger image.

6. The method of claim 1, wherein the mixed reality content further comprises a live feed video embedded with the trigger image to activate the mixed reality tool.

7. The method of claim 1, wherein the mixed reality content further comprises an animated isometric illustration of a business that is displayed via the mixed reality.

8. The method of claim 1, wherein the mixed reality content further comprises a simulcast video performance embedded within the trigger image to activate the mixed reality.

9. The method of claim 1, wherein the mixed reality content further comprises a fantasy world that grows in complexity over time with a plurality of stickers that are added to a scene in designated locations to introduce dynamic elements to the fantasy world.

10. The method of claim 1, wherein the mixed reality content further comprises video content associated with a creator as a sticker pack.

11. The method of claim 1, wherein the mixed reality content further comprises a live stream scene of protected wildlife, zoo enclosure and an animal sanctuary.

12. A system comprising:
at least one interface gateway configured to interface with at least one client device and a plurality of resource platforms, the at least one interface gateway comprising an integration orchestrator comprising at least one processor in communication with at least one non-transitory computer-readable medium having software instructions stored thereon, wherein, upon execution of the software instructions, the at least one processor is configured to:
scan a particular quick response digital code using a device associated with a user of a plurality of users;
access, and in response to the scan of the digital code, an interface associated with the device based on a first prompt to the user;
perform an authentication step to verify identity of the user and the device,
wherein the authentication step comprises a second prompt for a unique code;
trigger, in response to the performance of the authentication step, an action of a mixed reality tool based on the device hovering over a chosen image; and
generate mixed reality content utilizing a particular application based on the particular digital code.

13. The system of claim 12, wherein the mixed reality content comprises:
a digital postcard,
a digital sticker,
a digital sticker, and
a digital magnet.

14. The system of claim 12, wherein the mixed reality content further comprises a pre-recorded video message embedded with the trigger image.

15. The system of claim 12, wherein the mixed reality content further comprises a live feed video embedded with the trigger image to activate the mixed reality tool.

16. The system of claim 12, wherein the mixed reality content further comprises an animated isometric illustration of a business that is displayed via the mixed reality.

17. The system of claim 12, wherein the mixed reality content further comprises a simulcast video performance embedded within the trigger image to activate the mixed reality.

18. The system of claim 12, wherein the mixed reality content further comprises a fantasy world that grows in complexity over time with a plurality of stickers that are added to a scene in designated locations to introduce dynamic elements to the fantasy world.

19. The system of claim 12, wherein the mixed reality content further comprises video content associated with a creator as a sticker pack.

20. A device comprising:
at least one processor in communication with at least one non-transitory computer-readable medium having software instructions stored thereon, wherein, upon execution of the software instructions, the at least one processor is configured to:
scan a particular quick response digital code using a device associated with a user of a plurality of users;
access, and in response to the scan of the digital code, an interface associated with the device based on a prompt to the user;
perform an authentication step to verify identity of the user and the device,
wherein the authentication step comprises a prompt for a unique code;
trigger, in response to the performance of the authentication step, an action of a mixed reality tool based on the device hovering over a chosen image; and
generate mixed reality content utilizing a particular application based on the particular digital code.

21. A method comprising:
identifying, by a processor, a digital code associated with a trigger image;
determining, by the processor, user interaction with the digital code associated with the trigger image;
calculating, by the processor, a usage amount associated with the digital code based on a comparison of the digital code and an input code stored in an authentication database; and
providing, by the processor, access to mixed reality content based on the usage amount, wherein the calculated usage amount does not exceed an abnormal usage threshold.

22. A method comprising:
receiving, by a processor, a request to obtain an item, the item comprises a digital code;
registering, by the processor and in response to the obtaining of the item, user information to the digital code associated with the item;
determining, by the processor, user interaction with the item via the digital code and an interface associated with a device;
automatically providing, by the processor, access to mixed reality content via the interface associated with the device based on the user interaction with the digital code.

23. A device comprising:
at least one processor in communication with at least one non-transitory computer-readable medium having software instructions stored thereon, wherein, upon execution of the software instructions, the at least one processor is configured to:
identify a digital code associated with a physical item;
request access to data associated with the digital code via the physical item;
determine metadata associated with a user attempting to access the data associated with the digital code via the physical item;
verify the metadata associated with the user via a multi-factor authentication module, the multi-factor authentication module comprising a mixed reality tool; and
manipulate the data associated with the digital code via the physical item in response to a verification of the metadata.
